(19) United States
(12) Patent Application Publication
(10) Pub. No.: US 2012/0143707 A1
(43) Pub. Date: Jun. 7, 2012

(54) Executing Reader Application

(76) Inventor: Deepak Jain, Garland, TX (US)

(21) Appl. No.: 13/313,866

(22) Filed: Dec. 7, 2011

Related U.S. Application Data
(60) Provisional application No. 61/420,646, filed on Dec. 7, 2010.

(51) Int. Cl. G06Q 20/20; G06Q 20/40; H04W 4/00

(52) U.S. Cl. 705/18; 455/556.1; 455/552.1

(57) ABSTRACT

In some implementations, a cradle for a mobile device includes an electrical interface, an antenna, and a reader module. The electrical interface is configured to connect to a port of mobile devices. The mobile device is configured to wireless communicate with a cellular network. The antenna is configured to wirelessly communicate signals with customer devices. The reader module is connected to the antenna and configured to operate as a wireless reader, using the antenna, to the customer devices and authorize transactions using the mobile device to connect to the cellular network.

### CLAIM OF PRIORITY

This application claims priority under 35 USC §119(e) to U.S. Patent Application Ser. No. 61/420,646, filed on Dec. 7, 2010, the entire contents of which are hereby incorporated by reference.

### TECHNICAL FIELD

This invention relates to executing reader applications.

### BACKGROUND

Portable electronic devices and tokens have become an integrated part of the regular day to day user experience. There is a wide variety of common portable and handheld devices that users have in their possession including communication, business and entertaining devices such as cell phones, music players, digital cameras, smart cards, memory token and variety of possible combinations of the aforementioned devices and tokens. All of these devices share the commonality that consumer are accustomed to carrying them with them most of the time and to most places. This is true across the various demographics and age groups regardless of the level of the sophistication of the consumer, their age group, their technical level or background.

These common handheld devices offer options for expandable memory. Micro Secure Digital (microSD) is the popular interface across high-end cellphones while SD and MultiMediaCard (MMC) interfaces are also available in limited models. MicroSD is the least common denominator supported by the majority of these devices and tokens (in terms of size). In addition, adaptors are available to convert a MicroSD into MiniSD, SD, MMC and USB Although most popular MP3 player (iPOD) offer's a proprietary interface, competing designs do offer standard interfaces. Digital cameras offer mostly SD and MMC while extreme Digital (xD) is another option. Micro and Mini versions of these interfaces are also available in several models. Mini-USB is increasingly available across cellphones, digital cameras and MP3 players for synchronization with laptops.

### SUMMARY

The present disclosure is directed to a system and method for wirelessly executing financial transactions. A payment card includes an interface, a communication module, secure memory, a user-interface module, and a processing module. The interface connects to a slot of a mobile host device. The communication module wirelessly receives RF signals from and transmits RF signals to a retail terminal. The secure memory stores user credentials and a payment application used to execute financial transactions with the retail terminal. The user credentials and the payment application are associated with a financial institution. The user-interface module presents and receives information through the GUI of the mobile host device. The processing module executes the payment application using the user credentials in response to at least a transaction request received by the communication module and transmits a transaction response to the retail terminal based, at least in part, on the executed application.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an example reader system in accordance with some implementations of the present disclosure;

FIGS. 2A to 2E illustrate cross sectional views of some implementations of the attachment of FIG. 1;

FIG. 3 illustrates an example system for wireless authorizing transactions;

FIG. 4 illustrates an example reader of FIG. 1;

FIGS. 5A and 5B illustrate an example of antenna design 1;

FIGS. 6A and 6B illustrate another example of antenna design

FIGS. 7A and 7B illustrate another example of antenna design

FIGS. 8A-8C illustrate another example of antenna design;

FIGS. 9A-9D illustrate another example of antenna design;

FIGS. 10A and 10B illustrate another example of antenna design;

FIGS. 11A and 11B illustrate another example of antenna design;

FIGS. 12A and 12B illustrate another example of antenna design;

FIGS. 13A and 13B illustrate another example of antenna design; and

FIG. 14 is another example reader card.

Like reference symbols in the various drawings indicate like elements.

### DETAILED DESCRIPTION

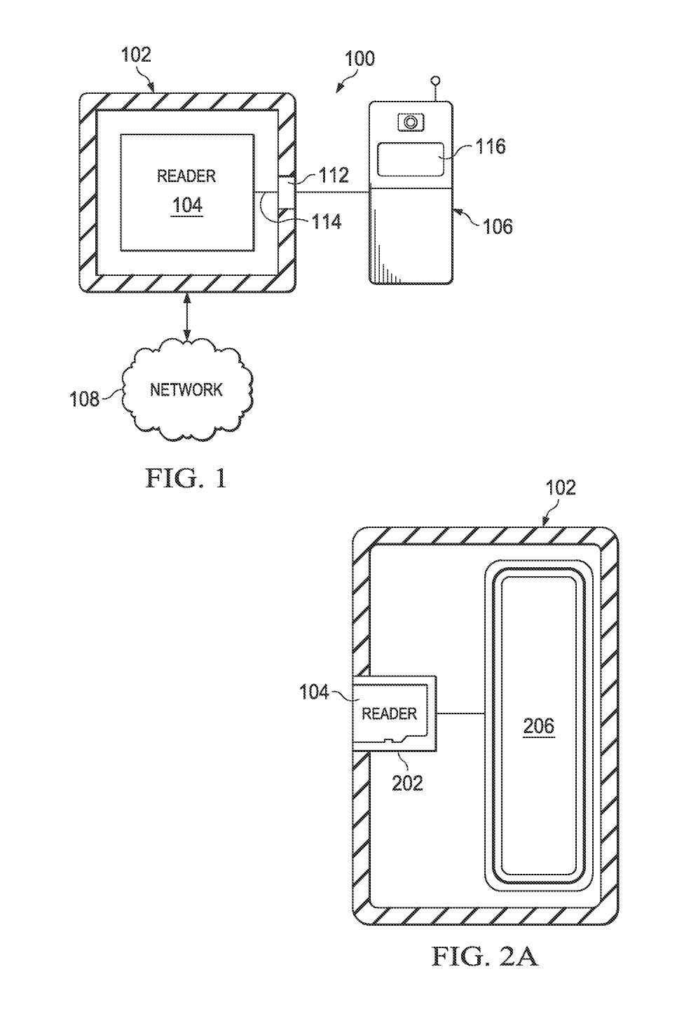

FIG. 1 is a block diagram illustrating an example system 100 for executing transactions using attachments integrating, incorporating or otherwise including devices that execute reader functionality. For example, the system 100 may include a microSecureDigital (microSD) card integrated into or otherwise included in a cover to a mobile device, connect to a port of the mobile device, and configured to operate as a wireless Point of Sale (POS) device. Aside from microSD, the system 100 may connect a reader device to mobile device using other interfaces such as, for example, MultiMediaCard (MMC), SD, miniSD, Firewire, iDock, USB, miniUSB, microUSB and/or others. By including reader devices (e.g., reader cards) in attachments, the system 100 may upgrade a mobile device to execute reader functions (e.g., transaction approval with transaction processor) in transactions without requiring additional hardware, software, and/or firmware for the mobile device and/or without requiring the mobile device to execute reader applications including processing unencrypted credentials. For example, the system 100 may connect a reader device to execute financial transactions with individuals and transmit requests for transaction authorizations to third-parties using the mobile device independent of updating the mobile device with additional software. In some implementations, the system 100 may include an element configured to switch between a plurality of different operational modes, such as card emulation, a reader, and peer-to-peer (P2P), independent of updating the associated mobile device with additional hardware, software, and/or firmware. In these cases, the element may operate each of these modes independent of the mobile device processing unencrypted confidential information. In addition, the system 100 may only use the mobile device to provide the function of a screen, keyboard and internet connection and may not execute the reader application which is executed in an attachment to the mobile device such as a microSD card.

The reader device may request approval from other entities such as an access control transaction with an enterprise network, a ticket purchase transaction with a transit authority, an identity validation transaction with a government agency, and/or others. In some implementations, the reader device may directly request approval for transactions with different institutions using a wireless connections (e.g., cellular, WiFi) of the mobile device. In addition, the system 100 may encrypt confidential information before using the wireless connection of the mobile device. In other words, a reader device included with the attachment may execute a transaction with a customer device using the credentials presented by the user to the reader device and request authorization using transaction processors with the mobile device solely processing encrypted confidential information. The credentials presented by the user may correspond to financial data (credit/debit/prepaid/gift account), or subscription data (membership/transit pass) or identification data (driving license, passport, access badge) or other transaction information (birth date, expiry date, coupon codes etc.) needed by the reader device to process the transaction. In such implementations, the reader device may encrypt an identity of a user and associated credentials and respect to the approval of the transactions from a third-party such as a transaction processor. In doing so, the mobile including the reader device may operate as a wireless POS reader. In some cases, the reader device may operate as an offline reader where it is able to execute an offline algorithm to check the validity of the transaction information and approve the transaction without connecting to any back-end transaction processor. Example of such reader devices could include door locks in hotel rooms/homes/automobiles) or offline smart card POS terminals, toll readers, pay-per-view devices connected to entertainment systems and video gaming systems.

There can be several modes of operation of a mobile POS device. One mode may include merchant intervention (normal POS at a retail store). In this mode, a merchant initiates a transaction by scanning the items purchased with the device automatically calculating the transaction amount. Once the final transaction amount is determined, the reader functionality may be activated. In another mode, the POS may be a vending machine or a self-service kiosk where the user makes his own purchase and the reader functionality is activated upon checkout. In yet another mode, the POS may be continuous polling an area for a transaction such reader functionality is substantially continuously running (e.g., a transit turnstile, a door lock).

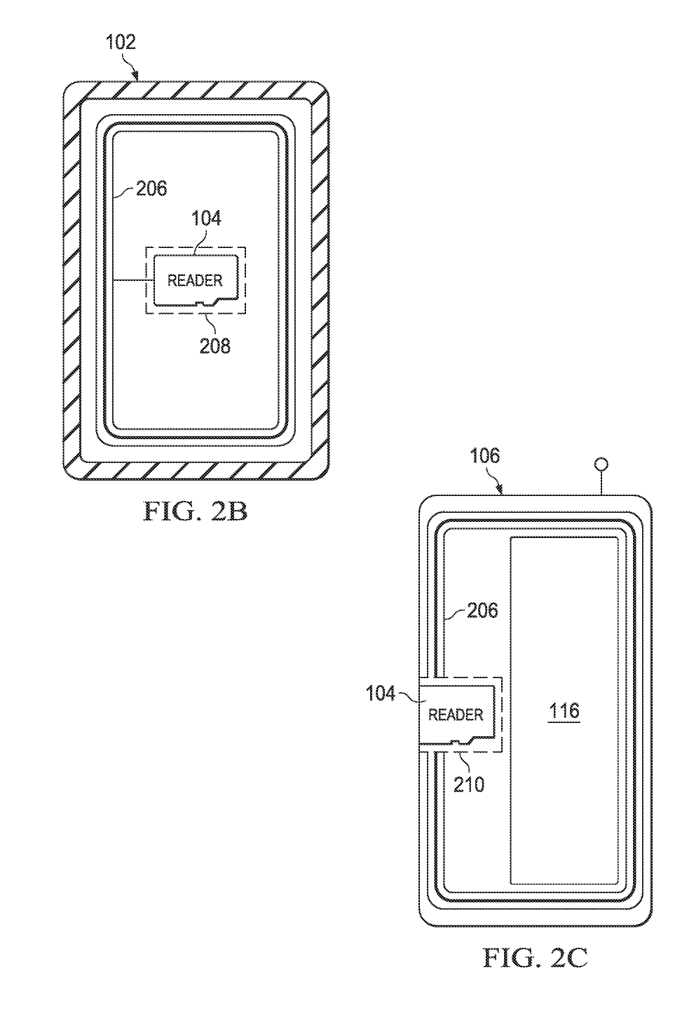

At a high level, the system 100 includes an attachment 102, a reader 104, a mobile device 106 and a network 108. The attachment 102 defines an opening configured to include the reader 104, a connector 112 for connecting to the mobile device 106, and a circuit 114 for communicably connecting the slot 110. The attachment 102 may update the mobile device 106 with a reader 104. In some implementations, the attachment 102 encloses at least a portion of the mobile device 106 such as a cover or cradle (see FIGS. 2A, B, and E) or the attachment 102 may comprise an element designed insertable in the mobile device 106 (see FIGS. 2C and D). In some examples, the attachment may encapsulate, enclose or otherwise include the reader chip and the antenna (e.g., cover, microSD). In some examples, the antenna inside the attachment may be amplified by a booster sticker placed in various configurations on the mobile device 106, as discussed below. In the case of enclosing a portion of the mobile device 106, the attachment 102 may include other aspects that expose ports of the mobile device 106 for connecting with external peripherals such that the attachment 102 does not substantially interfere with such connections. In other words, the attachment 102 may either include ports substantially aligned with ports of the mobile device 106 or provide openings that allow substantially unrestricted access to the original ports of the device 106. In some implementations, the attachment may replicate and/or replace a port of the mobile device 106 by another port contained inside the attachment that provides substantially the same functionality as the original port of the mobile device. The mobile device 106 may be communicable coupled to the network 108. The mobile device 106 includes a Graphical User Interface (GUI) 116 for presenting information to and/or receiving information from users.

The attachment 102 can include any software, hardware, and/or firmware configured to update the mobile device 106 with reader functionality. In some implementations, the attachment 102 may include a slot for receiving the reader 102 and/or the reader 102 may be integrated into the attachment 102. For example, the attachment 102 may include a microSD slot for receiving the reader 104 and a physical interface for connecting to a port of the mobile device. In this example, the attachment 102 may connect the microSD slot to the mobile device 106 using the physical interface. In some implementations, the slot may comprise an MMC, miniMMC, microMMC, SD, miniSD, microSD, miniUSB, USB, microUSB and/or other slots. The slot may include an opening such that the reader 104 may be inserted after the mobile device 106 is inserted into the attachment 102. In some implementations, the slot may be formed in the rear surface such that attachment 102 is removed or at least portion moved away from the surface of the mobile device 106 to insert the reader 104. In other implementations, the attachment 102 may define a space that encapsulates the reader 104 into the body of the attachment 102. For example, the attachment 102 may be a cover or a cradle that encapsulates the reader 104. In these instances, the reader 104 may not be removable without damaging the attachment 102.

In some implementations, the attachment 102 may include one or more of the following: one or more slots for external devices (e.g., memory, wireless transaction cards); one or more connectors that connect to the mobile device 106; one or more circuits for connecting the one or more slots to the one or more connectors; a conversion module that converts signals between different formats; a biometric reader that determines biometric information of a user of the mobile device 106; one or more voids defined by the body of the attachment 102; the attachment 102; and/or other elements. In some implementations, the attachment 102 may be formed of a flexible material such as, for example, silicone rubber, a soft neoprene, and/or other material. The opening formed by the attachment 102 may be substantially the same as or less than the dimensions of the mobile device 106. In the case of the opening dimensions being less, the attachment 102 may be slightly flexible to stretch over the mobile device 106. The attachment 102 may substantially maintain attributes of the mobile device 106, such as dimensions, accessibility to peripherals as provided by the device, charging, battery life, signal strength, access to display and all other input devices, connectivity to the wireless network if any, interface capability to a PC if any and any other features provided by the device. In maintaining the attributes, the added functionality may not degrade the device performance in any manner such that certification by regulatory authorities (e.g., FCC) and warranty by the issuer of the device 106 is compromised.

The connector 112 includes at least a portion that connects to a port of the mobile device 106. The connector 112 may include a USB, iDock, microUSB, Firewire, Serial, and/or other connectors offered by the mobile device 106. In some implementations, the connector 112 may include a first interface for connecting to the mobile device 106 and a second interface for connecting with external devices. The second interface may be substantially similar in dimensions and interface capabilities as the original connector of the mobile device 106. In these instances, the connector 112 may pass one or more signals from external devices to the mobile device 106 without, for example, interfering with the connecting to the reader 104. For example, the connector 112 may include a second interface that connects with the power supply of the mobile device 106 and passes the signal to the mobile device 106 for charging. The circuit 114 can include any software, hardware, and firmware for communicably connecting the reader 104 with the connector 112. For example, the circuit 114 may include one or more wired connections between the reader 104 and the connector 112. In addition, the circuit 114 may also include a booster antenna that may enhance the signal reception capability of the mobile device 106 and/or the signal reception capability of the reader 104. In some implementations, the circuit 114 may execute one or more of the following: pass signals between the reader 104 and the connector 112; translated or otherwise convert signals between forms compatible with the reader 104 and forms compatible with the mobile device 106; detect biometric information of a user of the mobile device 106; manage access to the reader 104 based, at least in part, on detected biometric information; enhance signal reception of the host device via an integrated booster antenna; enhance signal reception of the reader 104; provide access to software and system on the device inserted into the slot for an application residing on the mobile device; and/or other processes.

The reader 104 can include any software, hardware, and/or firmware configured to operate as a wireless reader. For example, the reader 104 may wirelessly execute transactions with a customer device such as a fob or credit card or mobile phone. In some implementations, the reader 104 may authorize the transaction with third parties using the mobile device 106 independent of the mobile device 106 processing unencrypted confidential information. In other words, the reader 104 may wirelessly execute transactions with the mobile device 106 transmitting authorization requests to third parties including encrypted credentials. In addition, the reader 104 may operate in each of a plurality of different modes, such as card emulation, a reader, and peer-to-peer (P2P), independent of updating the mobile device 106 with additional hardware, software, and/or firmware. In these cases, the reader 104 may operate in each of these modes independent of the mobile device processing unencrypted confidential information.

The reader 104 may execute transactions with user devices using short range signals such as NFC (e.g., ISO 18092/ECMA 340), ISO 14443 type A/B, ISO 15693, Felica, MiFARE, Bluetooth, Ultra-wideband (UWB), Radio Frequency Identifier (RFID), contactless signals, proximity signals, and/or other signals. In some implementations, the reader 104 may include one or more chipsets that execute an operating system and NFC applications to independently execute the transaction without the mobile device 106 processing confidential information. In doing so, the mobile device 106 does not require additional hardware, software, and/or firmware to wirelessly execution a transaction with user devices such as an NFC transaction and substantially ensures that confidential information is not processed outside of a secure chipset. In some implementations, the reader 104 may execute one or more of the following: wirelessly receive a request from a user device to execute a transaction; translate between wireless protocols and protocols compatible with the reader 104; translate between reader protocols and protocols compatible with mobile device 106; present and receive information through the GUI 116; decrypt and encrypt information wirelessly transmitted between the reader 104 and the individual device; execute applications locally stored in the reader 104; selectively switch the antenna of the reader 104 on and off based, at least in part, on one or more events; execute authentication processes based, at least in part, on information received, for example, through the GUI 116; transmit a transaction challenge to the user device; store, at least in part, details of the transaction executed between place between the reader 104 and the user device; generate and/or present alerts (e.g., audio-visual alerts) to the user through the GUI 116; generate and/or wirelessly transmit request for transaction approvals to the financial institution using the mobile device 106 if cellular/WiFi capable; and/or others.

In some implementations, the reader 104 may initiate a transaction in response to at least a user selecting a graphical element in the GUI 116. The reader 104 may initiate a transaction with the user device in response to at least wireless request transmitted by the POS 114. In some implementations, the reader 104 may selectively switch the antenna between an on and off state in response to one or more events. The one or more events may include a user request, completion of transaction, connection of reader 104 to a different mobile device, location change, timer events, detection of incorrect PIN entered by the user, change of wireless network that the device is connected to, message received from the financial institution using wireless communication methods such as SMS, and/or other events. For example, the reader 104 may receive one or more commands to switch the antenna off from a cellular network (not illustrated) through the mobile device 106. In some implementations, the reader 104 may request user identification such as a PIN, a user ID and password combination, biometric data or signature, and/or others.

In regards to translating between protocols, the reader 104 may process information in, for example, ISO 7816, Single Wire Protocol, NFC-WI protocol, a standard security protocol, and/or others. In this case, the reader 104 may translate between an NFC protocol (e.g., ISO 18092) and the reader protocol. In some implementations, the reader 104 may interface the mobile device 106 through a physical interface such as MicroSD, Mini-SD SD, MMC, miniMMC, microMMC, USB, miniUSB, microUSB, firewire, Apple iDock, and/or others. In regard to security processes, the reader 104 may implement one or more encryption algorithms to secure transaction information such as card number (e.g., credit card number, debit-card number, bank account number), PIN, and/or other security related information. The security related information may include an expiry date, card verification code, user name, home phone number, user zip code and/or other user information associated with verifying an identity of the card holder. In some implementations, the reader 104 may execute private key (symmetric algorithms) such as DES, TDES and/or others or public key (asymmetric algorithms) such as RSA, elliptic curves, and/or others. In addition, the reader 104 may include memory (e.g., Flash, EEPROM) for storing user data, applications, offline Webpages, and/or other information. In regards to applications, the reader 104 may execute a locally stored application and present information to and received information from the user through the GUI 116. In addition, the reader 104 may present offline Web pages to the user using the GUI 116. In connection with an initiated transaction, the reader 104 may automatically present an offline Web page through the GUI 116. In some implementations, the offline Web page may be associated with a financial institution 106. In some implementations, the reader 104 can execute a set of initialization commands in response to at least insertion into the mobile device 106. These initialization commands may include determining device related information for the mobile device 100 (e.g., phone number, signature, connected network information, location information and other available properties), determining user relating information (e.g., PIN code, activation code), incrementing counters, setting flags and activating/deactivating functions according to pre-existing rules and/or algorithms. In some implementations, the reader 104 substantially maintains attributes of the mobile device 106, such as dimensions, accessibility to peripherals as provided by the device, charging, battery life, signal strength, access to display and all other input devices, connectivity to the wireless network if any, interface capability to a PC if any and/or any other features provided by the device. The added functionality may not compromises the device performance in any manner, thereby preserving its certification by regulatory authorities such as FCC and the issuer of the device (e.g., warranty), such as an institution.

In some implementations, the reader 104 may automatically execute one or more fraud control processes. For example, the reader 104 may identify an operational change and automatically transmit a notification to the transaction processor based, at least in part, on the identified change. The reader 104 may execute two fraud control processes: (1) determine a violation of one or more rules; and (2) automatically execute one or more actions in response to at least the violation. In regards to rules, the reader 104 may locally store rules associated with updates to operational aspects of the reader 104. For example, the reader 104 may store a rule indicating a change in mobile host device 106 is an operational violation. In some implementations, the reader 104 may store rules based, at least in part, on updates to one or more of the following: phone number of host device 106; MAC address of host device 106; network wirelessly connected to host device 106; location of host device; and/or other aspects. In response to one or more events matching or otherwise violating rules, the reader 104 may execute one or more processes to substantially prevent or otherwise notify the financial institutions 106 of potentially fraudulent activity. For example, the reader 104 may execute a command to block an associated user account and/or the reader 104. Alternatively or in addition, the reader 104 may transmit a command to the financial institution 106 to call the mobile host device 106. In some implementations, the reader 104 may execute a command based, at least in part, on an event type. In some examples, the reader 104 may initiate a call with the institution 106 in response to at least a change in number of the host device 106. In some examples, the reader 104 may re-execute an activation process in response to at least a specified event type. An activation process may include activating the transaction card and/or financial account. In some implementations, the reader 104 may execute a command to disconnect the GUI 116 from the reader 104. The reader 104 may present a disconnection notification through the GUI 116 prior to executing the command. In some implementations, the reader 104 may transmit a command to the institution 106 to deactivate an account associated with the card 112.

The mobile device 106 comprises an electronic device operable to interface with the attachment 102 using one or more ports. For example, the mobile device 106 may have an iDock port that connects with the attachment 102. As used in this disclosure, the mobile device 106 is intended to encompass tablet computers (e.g., iPad), UMPCs, cellular phones (e.g., iPhone), data phones, pagers, portable computers, SIP phones, smart phones, personal data assistants (PDAs), digital cameras, MP3 players, camcorders, one or more processors within these or other devices, or any other suitable processing devices capable of communicating information with the attachment 102 through one or more ports and may not have otherwise have a slot for external card 104 could be directly plugged in. The one or more ports may include, for example, a USB port, an iDock port, a FireWire port, a serial port and/or any other interface port provided by the mobile device for connectivity with peripherals, and/or other ports. In some implementations, the mobile devices 106 may be based on cellular radio technology. For example, the mobile device 106 may be a PDA operable to wirelessly connect with an external or unsecured network. In another example, the mobile device 106 may comprise a digital multimedia player that includes an input device, such as a keypad, a jog wheel, a jog dial, touch screen, or other device that can accept information or allows selection of user interface elements, and an output device that conveys information associated with the system 100, including digital data, visual information, or GUI 116.

The GUI 116 comprises a graphical user interface operable to allow the user of the mobile device 106 to interface with at least a portion of the system 100 for any suitable purpose, such as executing transactions and/or and presenting transaction history. Generally, the GUI 116 provides the particular user with an efficient and user-friendly presentation of data provided by or communicated within the system 100 and/or also an efficient and user-friendly means for the user to self-manage settings and access services offered by an institution. The GUI 116 may comprise a plurality of customizable frames or views having interactive fields, pull-down lists, and/or buttons operated by the user. The term graphical user interface may be used in the singular or in the plural to describe one or more graphical user interfaces and each of the displays of a particular graphical user interface. The GUI 116 can include any graphical user interface, such as a generic web browser or touch screen that processes information in the system 100 and presents the results to the user.

Network 108 facilitates wireless or wired communication between institutions and any other local or remote computer, such as the mobile device 106. Network 108 may be all or a portion of an enterprise or secured network. While illustrated as single network, network 108 may be a continuous network logically divided into various sub-nets or virtual networks without departing from the scope of this disclosure, so long as at least a portion of network 108 may facilitate communications with the mobile device 106. In some implementations, network 108 encompasses any internal or external network, networks, sub-network, or combination thereof operable to facilitate communications between various computing components in system 100. Network 108 may communicate, for example, Internet Protocol (IP) packets, Frame Relay frames, Asynchronous Transfer Mode (ATM) cells, voice, video, data, and other suitable information between network addresses. Network 108 may include one or more local area networks (LANs), radio access networks (RANs), metropolitan area networks (MANs), wide area networks (WANs), all or a portion of the global computer network known as the Internet, and/or any other communication system or systems at one or more locations.

FIGS. 2A-E illustrate cross-sectional views of the attachment 102 of FIG. 1. In particular, the views illustrate the components of the attachment 102 that at least augment the mobile device 106 with the reader 104. In FIG. 2A, the attachment 102 includes a slot 202 defined in the attachment 102 (e.g., microSD slot), a reader 104, and an antenna 206. The slot 202 is configured to receive the reader 104 and connect the reader 202 to the antenna 206. The reader 104 may be wirelessly coupled to the antenna 206 or directly connected to the antenna 206. At least a portion of the antenna 206 may be encapsulated in the attachment 102 and/or adjacent a surface of the attachment. In some implementations, the antenna 206 may extend the transaction range of the reader 104 for wirelessly executing transactions with local user devices. Referring to FIG. 2B, the reader 104 is encapsulated in the attachment 102. In particular, the attachment 102 defines a void 208 that includes the reader 104. In addition, the reader 104 is connected to the antenna 206. The reader 104 may be wirelessly coupled to the antenna 206 or directly connected to the antenna 206. At least a portion of the antenna 206 may be encapsulated in the attachment 102 and/or adjacent a surface of the attachment. In some implementations, the antenna 206 may extend the transaction range of the reader 104 for wirelessly executing transactions with local user devices. Referring to FIG. 2C, the mobile device 106 defines a slot 210 for receiving the reader 104. As previously mentioned, the reader 104 may be housed in an SD card (e.g., microSD), a USB dongle, and/or other form factor configured to insert in the slot 210. The reader 104 may be wirelessly coupled to the antenna 206 or directly connected to the antenna 206. At least a portion of the antenna 206 may be included in the mobile device 106 and/or adjacent a surface of the mobile device 106. For example, the antenna 206 may be encapsulated in the back cover and/or battery-back cover. In some implementations, the antenna 206 may extend the transaction range of the reader 104 for wirelessly executing transactions with local user devices. Referring to FIG. 2D, the mobile device 106 includes the reader 104. For example, the reader 104 may be included in a chip carrier and inserted into a board of the mobile phone 106. In these instances, the reader 104 may comprise chipsets enclosed in a container and wired to external pins. The reader 104 may be wirelessly coupled to the antenna 206 or directly connected to the antenna 206. At least a portion of the antenna 206 may be included in the mobile device 106 and/or adjacent a surface of the mobile device 106. For example, the antenna 206 may be encapsulated in the back cover and/or battery-back cover. In some implementations, the antenna 206 may extend the transaction range of the reader 104 for wirelessly executing transactions with local user devices. Referring to FIG. 2E, the attachment 102 comprises a cradle for receiving a mobile device 106 such as a phone and/or tablet computer. The attachment 102 forms a void 214 that includes the reader 104. The reader 104 may be inserted into the void 214, or the attachment 102 may encapsulate at least a portion of the reader 104. In addition, the reader 104 is connected to a processor 216 configured to operate one or more peripherals through connectors 218a-d. For example, the processor 216 may operate a document scanner, a biometric scanner, a printer, and/or other elements. In some implementations, the processor 216 may transmit commands to peripherals in connection with a transaction with the reader 104. For example, the reader 104 may execute a paperless deposit by instructing a document scanner to scan a check using the processor, verify an identity of the depositor through a fingerprint scanner, and print a deposit slip using an attached printer. The reader 104 may be wirelessly coupled to the antenna 206 or directly connected to the antenna 206. At least a portion of the antenna 206 may be included in the mobile device 106 and/or adjacent a surface of the mobile device 106. For example, the antenna 206 may be encapsulated in the body of the attachment 102. In some implementations, the antenna 206 may extend the transaction range of the reader 104 for wirelessly executing transactions with local user devices. In some implementations, the cradle 102 may comprises a cradle for an Android tablet, Microsoft Windows Tablet, Apple Table, and/or other tablets. By combining the cradle 102 including the reader 104 and a tablet, this combination may operate as a microATM and/or self-service banking kiosk allowing user identification (via mag stripe swipe, NFC read, fingerprint sensor, IRIS scanner, others) and also other banking functions such as funds transfer, deposits, and/or others. In some implementations, the combination may operate as a mobile POS. The cradle 102 and a tablet may be an expanadable peripheral system that connects other accessories like printer, scanners, and/or others.

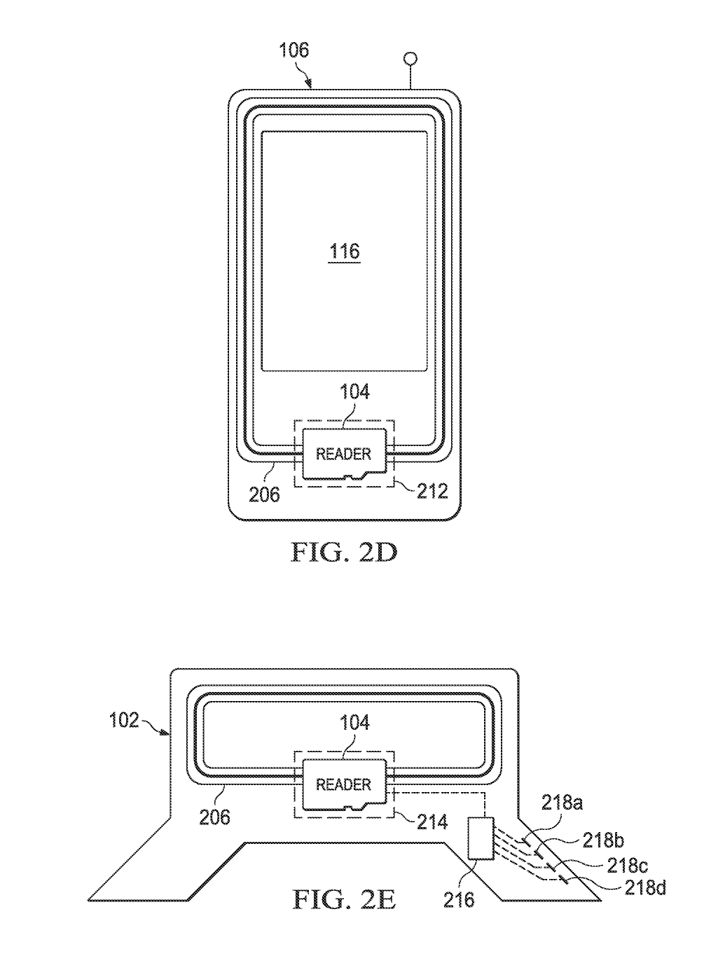

FIG. 3 is a block diagram illustrating an example transaction system 300 for wirelessly communicating transactions information using cellular radio or WiFi technology. For example, the system 300 may wirelessly communicate a transaction authorization request from the reader 104 to the wireless access network 304 using cellular radio technology of the mobile device 106. Alternatively, the system 300 may communicate with the transaction processor through the internet using the WiFi modem of the mobile device and a WiFi network connected to the internet. In some implementations, wireless technology may include Long Term Evolution (LTE), Global System for Mobile Communication (GSM), Code Division Multiple Access (CDMA), Universal Mobile Telecommunications System (UMTS), WiMAX, Circuit Switched Data (dial-up) and/or any other wireless technology. The institutions 106 may assign one or more mobile host devices 106 to a reader 104 in response to one or more events. In some examples, the user may register the one or more mobile devices 106 with the institution 302 in connection with, for example, requesting the associated reader 104. In some examples, the reader 104 may register the mobile host device 106 with the institution 302 in response to at least an initial insertion into the device 106. Regardless of the association process, the system 300 may use the wireless capabilities of the host devices 106 to communicate information between the institutions 106 and the reader 104.

Institutions 302a-c can include any enterprise that may authorize transactions received through the network 108. For example, the institution 302a may be a credit card provider that determines whether to authorize a transaction based, at least in part, on information received through the network 108. The institution 302 may be a credit card provider, a bank, an association (e.g., VISA), a retail merchant (e.g., Target), a prepaid/gift card provider, an internet bank, a transit/ticketing authority, a government entity, a club, and/or others. In general, the institution 302 may execute one or more of the following: receive a request to authorize a transaction; identify an account number and other transaction information (e.g., PIN); identify funds and/or a credit limit associated with the identified account; identify access privileges associated with the user account; determine whether the transaction request exceeds the funds and/or credit limit and/or violates any other rules associated with the account; transmit an indication whether the transaction has been accepted or declined; and/or other processes. In regards to banking, the institution 302 may identify an account number (e.g., bank account, debit-card number) and associated verification information (e.g., PIN, zip code) and determine funds available to the account holder. Based, at least in part, on the identified funds, the institution 302 may either accept or reject the requested transaction or request additional information. As for encryption, the institution 302 may use a public key algorithm such as RSA or elliptic curves and/or private key algorithms such as TDES to encrypt and decrypt data.

The contactless smart card 310 is a user device with embedded integrated circuits that process information. For example, the user device 310 may wirelessly receive transaction information, process the information using embedded applications and wirelessly transmit a response. The user device 310 may be a user identification and credential device such as contactless card, a contactless sticker attached to a mobile device or another user item, a contactless key fob or another contactless form factor such as watch, bracelet etc., an NFC mobile phone operating in card emulation mode, and/or others. Note that the NFC mobile phone could also represent a generic mobile phone connected with an NFC accessory such as microSD, mobile device cover/dongle or Bluetooth NFC dongle The user device 310 may wirelessly communicate with card readers 104 through RFID induction technology at data rates of 106 to 848 kbit/s. The device 310 may wirelessly communicate with proximate readers between 10 cm (e.g., ISO/IEC 14443, NFC, MiFare, Felica) to 50 cm (e.g., ISO 15693). The user device 310 may be a contactless memory card or contactless microprocessor card. In general, memory cards include only non-volatile memory storage components and may include some specific security logic. Microprocessor cards include volatile memory and microprocessor components. In some implementations, the user device 310 can have dimensions of normally credit card size (e.g., 85.60×53.98×0.76 mm, 5×15×0.76 mm). In some implementations, the user device 310 may be a fob or other security token. The user device 310 may include a security system with tamper-resistant properties (e.g., a secure cryptoprocessor, secure file system, human-readable features) and/or may be configured to provide security services (e.g., confidentiality of stored information).

In some aspects of operation, the institution 302 may wirelessly communicate with the mobile host device 106 using the wireless access network 304. For example, the institution 302 may transmit information to the mobile host device 106 in response to at least an event. The information may include, for example, transaction information (e.g., transaction receipt, transaction history), scripts, applications, Web pages, and/or other information associated with the institutions 302. The event may be a merchant intervention initiated by mobile POS device or may be initiated by the consumer. In addition, the event may include completing a transaction, receiving an authorization request from the reader 104 connected to the mobile host device 106, and/or others. For example, the institution 302 may identify a mobile host device 106 associated with a reader 104 that executed a transaction and transmit transaction information to the mobile host device 106 using the wireless access network 304. In using the wireless access network 304, the institutions 302 may transmit information to the reader 104 without requiring a wired connection. In addition or alternatively, the institution 302 may request information from the mobile host device 106, the reader 104 and/or the user using the wireless access network 304. For example, the institution 302 may transmit a request for transaction history to the reader 104 through the wireless access network 304 and the mobile host device 106. In some implementations, the mobile host device 106 may operate as a mobile Point of Sale (POS) terminal configured to wirelessly execute transactions with the smart card 310. For example, a vendor may be mobile (e.g., a taxi driver) and may include a mobile host device 106 with a reader 104. In this example, the reader 104 may wirelessly receive account information from the smart card 310 and transmit an authorization request to the institution 302 using the mobile host device 106 and the wireless access network 304.

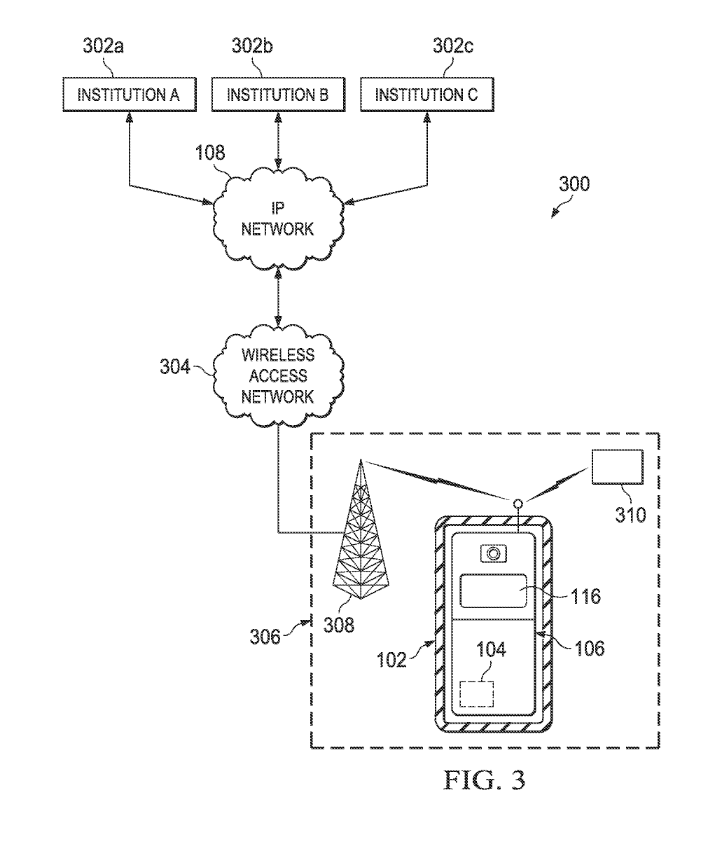

FIG. 4 is a block diagram illustrating an example reader 104 in accordance with some implementations of the present disclosure. For example, the reader 104 of FIG. 1 may be implemented in accordance with the illustrated reader. In general, the reader 104 may independently access services and/or transactions. The reader 104 is for illustration purposes only and may include some, all, or different elements without departing from the scope of the disclosure.

As illustrated, the reader 104 includes a CPU 402, memory 404, a reader chip 406, a secure element 408, amplifying elements 410a and 410b and antenna 412. In this implementation, the reader 104 may switch between operating as a mobile POS device and a transaction card. In the case of the reader, the reader chip 406 controls communication with external transaction cards using the antenna 412 and controls communication with authorizing entities using an attached mobile device. In some implementations, the reader 104 may shut down or disconnect power supplies to elements that do not participate in transaction while operating as a reader. For example, the CPU 402 may shut down power to the secure element 408 during reader operations. In the case of a transaction card, the secure element 408 controls wireless communication with the external POS devices using the antenna 412. In this case, the reader chip 406 may providing pass through communication between the antenna 412 and the secure element 408. In some implementations, the connection between the reader chip 406 and the secure element 408 can be a digital connection in which case the reader chip 406 can execute analog to digital conversion and vice versa.

The antenna 412 wirelessly transmits and receives signals such as NFC signals. In some implementations, the amplifying elements 410a and 410b may dynamically adjust the amplification of the antenna 412 to tune the transmit and/or receive frequency. In some implementations, the antenna 412 can be a short range wireless antenna connected to an NFC inlay via a software switch such as an NAND Gate or other element to allow for code from the CPU 402 to turn the antenna 412 on and off.

The CPU 402 may transmit the switching command in response to an event such as a user request, completion of a transaction, and/or others. When switched on, the reader chip 406 is connected to the antenna 412 and executes one or more of the following: format signals for wireless communication in accordance with one or more formats; decrypt received messages and encrypt transmitted messages; authorize transactions with third parties using mobile device; and/or other processes. The memory 404 may include a secure and non-secured section. In this implementation, the secure memory 404 may store one or more user credentials that are not accessible by the user. In addition, the memory 404 may store offline Web pages, applications, transaction history, and/or other data. In some implementations, the memory 404 may include Flash (e.g., NAND) memory from 64 MB to 32 GB. In addition, the memory 404 may be partitioned into user memory and device application memory.

In some implementations, the CPU 402 may switch the antenna 412 between active and inactivate mode based, at least in part, on a personalization parameter defined by, for example, a user, distributor (e.g., financial institution, service provider), and/or others. For example, the CPU 402 may activate the antenna 412 when the reader 104 is physically connected to a host device and when a handshake with the host device is successfully executed. In some implementations, the CPU 402 may automatically deactivate the antenna 412 when the reader 104 is removed from the host device. In some implementations, the antenna 412 is always active such that the reader 104 may be used as a stand-alone access device (e.g., device on a keychain). In regards to the handshaking process, the CPU 402 may execute one or more authentication processes prior to activating the reader 104 and/or antenna 412. For example, the CPU 402 may execute a physical authentication, a device authentication, and/or a user authentication. For example, the CPU 402 may activate the antenna 412 in response to at least detecting a connection to the physical interface with the host device (e.g., SD interface) and successful installation of the device driver for mass memory access (e.g., SD device driver) on the host device. In some implementations, device authentication may include physical authentication in addition to a signature comparison of a device signature stored in memory (e.g., security module (SE)) that was created during first-use (provisioning) to a run-time signature calculated using, for example, a unique parameter of the host device. In the event no host device signature exists in the memory, the CPU 402 may bind with the first compatible host device the reader 104 is inserted into. A compatible host device may be a device that can successfully accomplish physical authentication successfully. If a host-device signature is present in the memory, the CPU 402 compares the stored signature with the real-time signature of the current host device. If the signatures match, the CPU 402 may proceed to complete the bootstrap operation. If the signatures do not match, host device is rejected, bootstrap is aborted and the reader 104 is returned to the mode it was before being inserted into the device.

User authentication may include verification of physical connection with a user using a PIN entered by the user, a x.509 type certificate that is unique to the user and stored on the host device, and/or other processes. Device and user authentication may verify a physical connection with device through comparison of a device signature and user authentication through verification of user PIN or certificate. In some implementations, the user can select a PIN or certificate at provisioning time. If this case, the CPU 402 may instantiate a software plug-in on the host device. For example, a software plug-in may request the user for his PIN in real time, read a user certificate installed on the device (e.g., x.509), and/or others. The operation of the software plug-in may be customized by the provider. Regardless, the returned user data may be compared with user data stored in the memory. In case of a successful match, the antenna 412 may be activated. In case of an unsuccessful match of a certificate, then reader 104 is deactivated. In case of unsuccessful PIN match, the user may be requested to repeat PIN attempts until a successful match or the number of attempts exceeds a threshold. The disk provider may customize the attempt threshold.

In regards to network authentication, the host device may be a cellphone such that the reader 104 may request network authentication prior to activation. For example, the reader 104 may be distributed by a Wireless Network Operator (WNO) that requires a network authentication. In this example, a flag in memory may be set to ON indicating that network authentication is required. If the flag is set to ON, a unique identity about the allowed network is locally stored in memory such a Mobile Network Code for GSM networks, a NID for CDMA networks, a SSID for broadband networks, and/or identifiers. If this flag is ON, the CPU 402 in response to at least insertion may request a special software plug-in to be downloaded to the host device and instantiated. This software plug-in may query the host device to respond with network details. In some cases, the type of unique network identity employed and the method to deduce it from the host device may be variable and dependent on the network provider and capability of the host device. If the locally-stored ID matches the request ID, the CPU 402 activated the antenna 412 to enable access or otherwise services are denied.

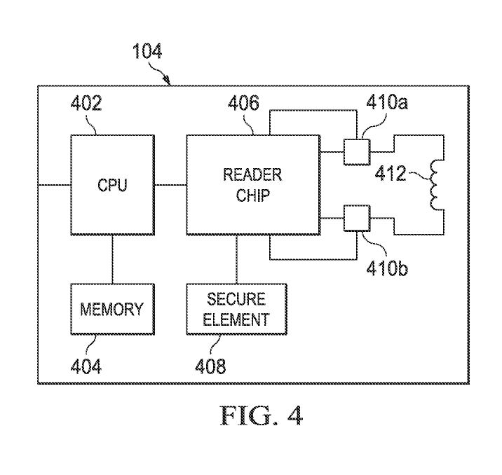

FIGS. 5A and 5B illustrate an example reader 104 in accordance with some implementations of the present disclosure. In the illustrated implementation, the reader 104 includes a shape and dimensions exactly the same or substantially similar to a standard MicroSD card. The reader 104 includes an antenna 502 for wirelessly communicating with, for example, individual user devices using RF signals and an SD interface 506 for physically interfacing a device (e.g., mobile device 106). The antenna 502 may be a flat coil (e.g., copper coil) integrated on one or more layers the MicroSD reader 104, a printed circuit (e.g., copper circuit) etched on one or more layers of the MicroSD reader 104, and/or other configuration for wirelessly transmitting and receiving RF signals. In some implementations, the antenna 502 may be substantially planar and adjacent at least a portion of the housing 508 of the reader 104 (e.g., top, bottom). The antenna 502 may include a width of at least approximately 9 mm and a length of at least approximately 14 mm. As illustrated in FIG. 5B, the antenna 502 is connected to a transaction circuit 510 (e.g., a reader chipset) using, for example, a tuning circuit that tunes the antenna 502 to one or more frequencies. The one or more frequencies may be based, at least in part, on the customer device or type of customer device. For example, the tuning circuit may tune the antenna 502 to 13.56 MHz for ISO 14443 related transactions. In some implementations, the antenna 502 may include insulation to substantially prevent signals from interfering with the circuit 510, mobile device 106, battery elements, and/or other elements that may be proximate to the reader 104. The reader 104 may include an amplifier circuit 504 to amplify (e.g., a factor of 10) signals generated by the antenna 502. In some implementations, the amplifier 504 may be of two types. For example, the amplifier 504 may be a passive amplifier that uses passive circuitry to amplify the RF signals received by the antenna and/or a powered active amplifier that uses the energy from the battery of the host device to operate the transaction circuit. In some implementations, the reader 104 may contain two additional RF interface pins 509A and 509B to allow the reader to use an external antenna, for example, an antenna contained in a separate housing for transactions and/or personalization.

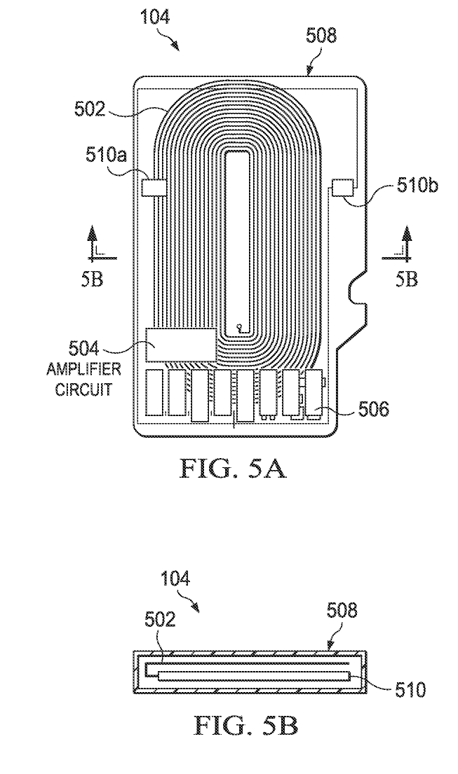

FIGS. 6A and 6B illustrate another example of the reader 104 in accordance with some implementations of the present disclosure. In the illustrated implementation, the reader 104 includes a three-dimensional antenna 602. For example, the antenna 602 may include a shape that is substantially helical such as a three-dimensional antenna coil. In addition, the reader 104 may include a housing 608 enclosing the antenna 602 and a transaction circuit. As illustrated in FIG. 6B, the antenna 602 may include a core 608 that substantially defines a length and a width of a three-dimensional shape of the antenna 602. In some implementations, the core 608 may comprise a middle segment of the reader 104 such that the width of the antenna coil 602 is substantially similar to the reader 104. The core 608 may reflect at least some wireless signals to substantially isolate the magnetic field from the transaction circuit 308, the mobile device 106, battery elements, and/or other elements proximate the antenna 602 in such a way that the magnetic field is concentrated in a direction substantially pointing away from the host device. The illustrated antenna 602 can be connected to the transaction circuit (e.g., reader chip 406). In some implementations, the antenna 602 may be connected to a tuning circuit that substantially tunes the antenna 602 to one or more frequencies compatible with, for example, a retail terminal 114. For example, the tuning circuit may tune the antenna 602 to 13.56 MHz for ISO 14443 related transactions. The reader 104 may include an amplifier circuit 604 to amplify (e.g., a factor of 10) wireless signals generated by the antenna 602. In some implementations, the amplifier 604 may be of two types. For example, the amplifier 604 may be a passive amplifier that uses passive circuitry to amplify the RF signals received by the antenna and/or a powered active amplifier that uses the energy from the battery of the host device to operate the transaction circuit.

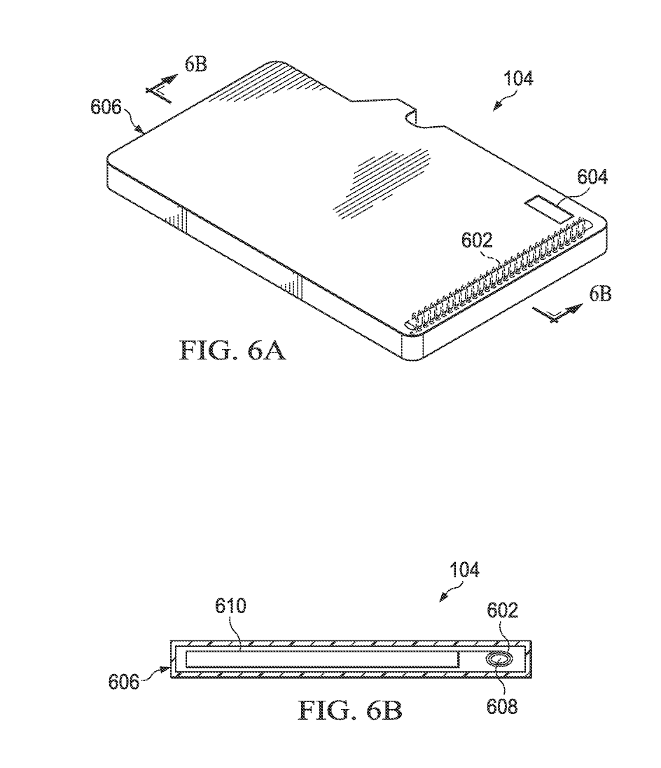

FIGS. 7A and 7B illustrate an example reader 104 including an external antenna 702 in accordance with some implementations of the present disclosure. In the illustrated implementation, the reader 104 can include an antenna 702 enclosed in a resilient member 704 and external to a housing 706 of the reader 104. The antenna 702 and the resilient member 704 may extend outside the SD slot during insertion of the housing 706. In some cases, the housing 706 may be substantially inserted into the slot of the device (e.g., mobile device 106). In the illustrated implementation, the housing 706 can include a shape and dimensions exactly the same or substantially similar to a standard MicroSD card. The antenna 702 wirelessly communicates with, for example, customer devices using RF signals. In addition, the reader 104 may include an SD interface 710 for physically interfacing a device (e.g., mobile device 106). The antenna 702 may be a substantially planar coil (e.g., copper coil) integrated into one or more layers, a printed circuit (e.g., copper circuit) etched into one or more layers, and/or other configuration for wirelessly transmitting and receiving RF signals. The enclosed antenna 702 and the housing 706 may form a T shape. In some implementations, the antenna 702 may be substantially planar and adjacent at least a portion of the housing 708 of the reader 104 (e.g., top, bottom). The antenna 702 may include a width in the range of approximately 9 mm and a length in the range of approximately 14 mm. The resilient member 704 may be rubber, foam, and/or other flexible material. In some implementations, a flat, cylindrical or other shaped block of ceramic antenna may be used instead of the resilient member 704 and antenna 702. As illustrated in FIG. 7B, the antenna 702 is connected to a transaction circuit 710 (e.g., a reader chip 406) using, for example, a tuning circuit that tunes the antenna 702 to one or more frequencies. The one or more frequencies may be based, at least in part, on the terminal and/or type of terminal (e.g., POS 114). For example, the tuning circuit may tune the antenna 702 to 13.56 MHz for ISO 14443 related transactions. In some implementations, the antenna 702 may include insulation using material (e.g., Ferrite) to substantially isolate and direct magnetic field signals away from interfering with the circuit 710, mobile device 106, battery elements, and/or other elements that may be proximate to the reader 104 in such a way that the magnetic field is concentrated in a direction substantially pointing away from the host device slot in which the transaction card is inserted. The reader 104 may include an amplifier circuit 712 to amplify (e.g., a factor of 10) signals generated by the antenna 702. In some implementations, the amplifier 712 may be of two types. For example, the amplifier 712 may be a passive amplifier that uses passive circuitry to amplify the RF signals received by the antenna and/or a powered active amplifier that uses the energy from the battery of the host device to operate the transaction circuit.

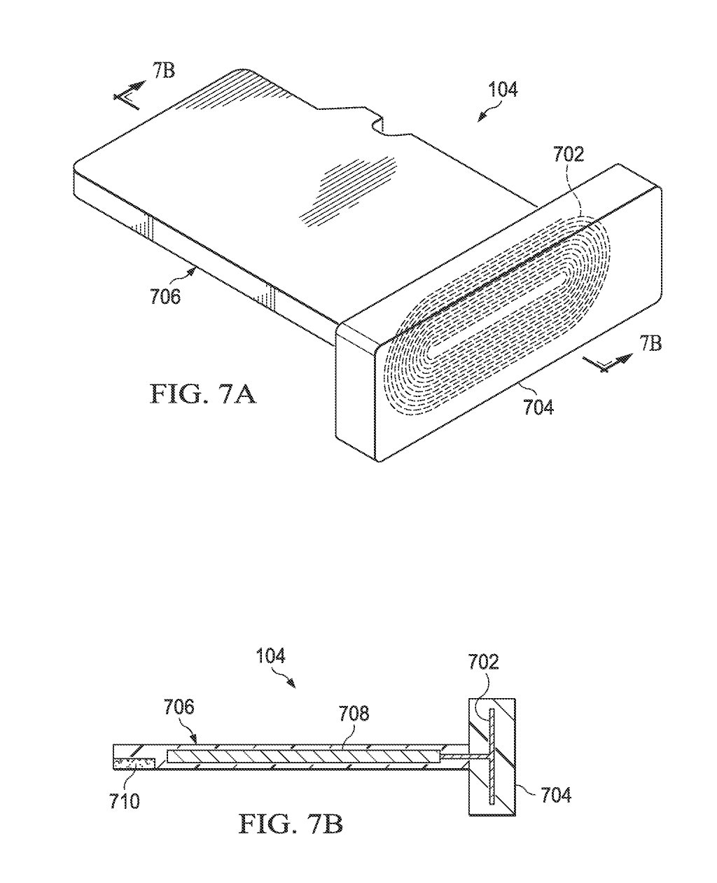

FIGS. 8A-C illustrate an example reader 104 including an external three-dimensional antenna 412 in accordance with some implementations of the present disclosure. In the illustrated implementation, the reader 104 can include an antenna 412 enclosed in a resilient member 804 and external to a housing 806 of the reader 104. The antenna 412 and the resilient member 804 may extend outside the SD slot receiving the housing 806. In some cases, the housing 806 may be substantially inserted into the slot of the device (e.g., mobile device 106). In the illustrated implementation, the housing 806 can include a shape and dimensions exactly the same or substantially similar to a standard MicroSD card. The antenna 412 wirelessly communicates with, for example, customer devices using RF signals. In addition, the reader 104 may include an SD interface 402 for physically interfacing a device (e.g., mobile device 106). The member 804 may include an arcuate outer surface and/or a substantially flat surface that abuts a portion of the housing 806. As illustrated in FIG. 8C, the antenna 412 may include a core 810 that substantially defines a length and a width of a three-dimensional shape of the antenna 412. The core 810 may reflect at least some wireless signals to substantially isolate the magnetic field from the reader 104, the mobile device 106, battery elements, and/or other elements proximate the antenna 412 in such a way that the magnetic field is concentrated in a direction substantially pointing outside the host device. In some implementations, the core 810 may include a cylindrical ferrite core around which the antenna 412 of the reader 104 is wrapped. In some implementations, the core 810 may substantially reflect signals away from the transaction card circuitry, mobile device 106, battery elements, and/or other elements that may be proximate to the reader 104 in such a way that the magnetic field is concentrated in a direction substantially pointing away from the host device. The antenna 412 may include a width in a range of 9 mm and a length in a range of 14 mm. The resilient member 804 may be rubber, foam, and/or other flexible material. As illustrated in FIG. 8B, the antenna 412 is connected to a transaction circuit 810 (e.g., a reader chip) using, for example, a tuning circuit that tunes the antenna 412 to one or more frequencies. The one or more frequencies may be based, at least in part, on the customer device and/or type of customer device. For example, the tuning circuit may tune the antenna 702 to 13.56 MHz for ISO 14443 related transactions. The reader 104 may include an amplifier circuit 812 to amplify (e.g., a factor of 10) signals generated by the antenna 412. In some implementations, the amplifier 812 may be of two types. For example, the amplifier 812 may be a passive amplifier that uses passive circuitry to amplify the RF signals received by the antenna and/or a powered active amplifier that uses the energy from the battery of the host device to operate the transaction circuit. In some implementations, the reader 104 may contain two additional RF interface pins 814a and 814b to allow the transaction card to use an external antenna, for example, an antenna contained in a separate housing for transactions and/or personalization.

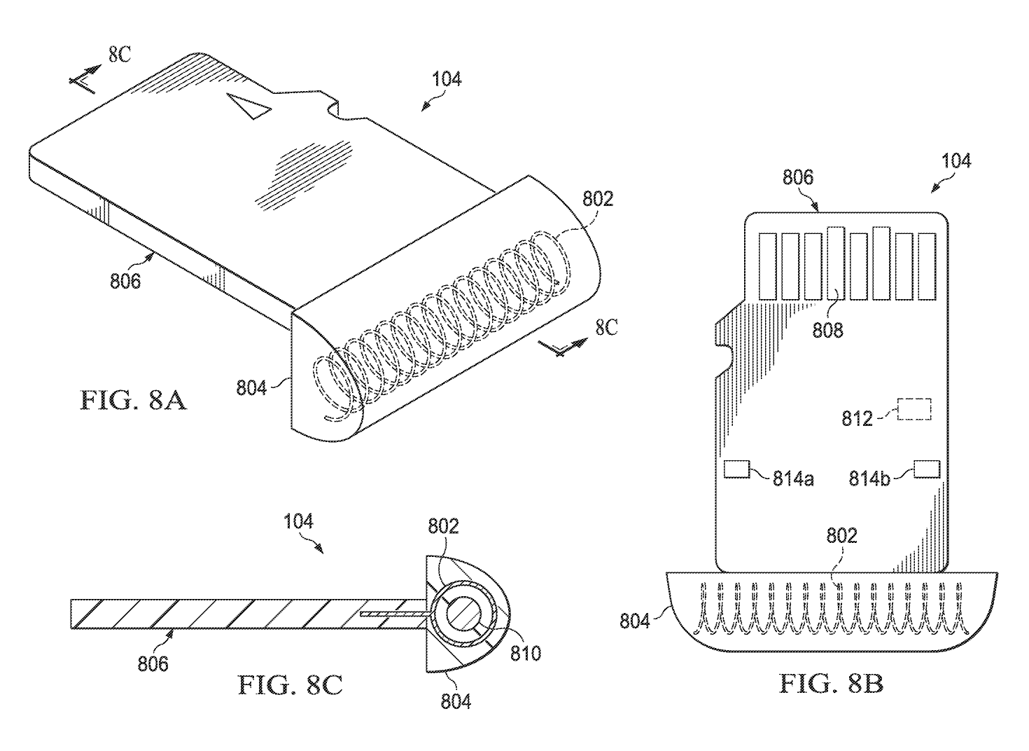

FIGS. 9A-9D illustrate an example reader 104 an antenna element 902 and a card element 904. In the illustrated implementations, the card element 904 can be inserted into the antenna element 902 to form the reader 104. The antenna element 902 may include an antenna 906 enclosed in a resilient member 908 as illustrated in FIG. 9B and include antenna connections 910 for connecting the antenna 906 to the card element 904. The card element 904 may include card connections 916 corresponding to the antenna connections 910 that connect to, for example, the reader chip. By selectively positioning the antenna element 902 and the card element 904, the antenna connections 910 may abut the card connections 916 to form an electrical connection between the two elements. In addition to an electric connection, this connection may also provide a mechanical lock between the antenna element 902 and the card element. Once attached, the reader chip may be connected to the antenna 906 using a tuning circuit that tunes the antenna 906 to one or more frequencies for wireless communicating with, for example, the customer device. For example, the tuning circuit may tune the antenna 906 to 13.56 MHz for ISO 14443 related transactions.

In some implementations, the card element 904 can include a width and a thickness the same or substantially the same as a standard MicroSD card such that at least a portion of the card element 904 may be inserted into a standard MicroSD slot. In some instances, the card element 904 may be 3-5 mm longer than a standard MicroSD card. The card element 904 may include a head protrusion that is slightly wider and/or thicker than a main body of the card element 904. The antenna element 902 typically extends outside of the MicroSD slot after insertion of the card element 904. In some implementations, the antenna element 902 may include a rounded curvature facing away from the slot during insertion and a flat surface on the other side. In some implementations, the antenna element 902 may form an opening having a width approximately 1-2 mm wide. The width of the opening may be approximately equal to the thickness of the main body of the card element 904. In some implementations, the width of the opening may match the thickness of the head protrusion of the card element 904. In the protrusion example, the thinner side of the card element 904 may be initially inserted into the antenna element 902. In some implementations, the head protrusion of the card element 904 after insertion may be substantially flush with the opening. In this instance, the antenna element 902 and the card element 904 may form a cap with flat ends connected by a curvature. The antenna element 902 may be soft rubber, foam, and/or other material that may conform to portions of an SD slot during insertion of the card element 904. The antenna 906 may be a flexible PCB including a thin copper antenna coil that is etched and/or mounted to form the antenna 906. In some implementations, the card element 904 may include a notch 914 for receiving a portion of the antenna element 902 such as the protrusion 912. In this case, the notch 914 and the protrusion 912 may substantially secure the card element 904 in the antenna element 902.

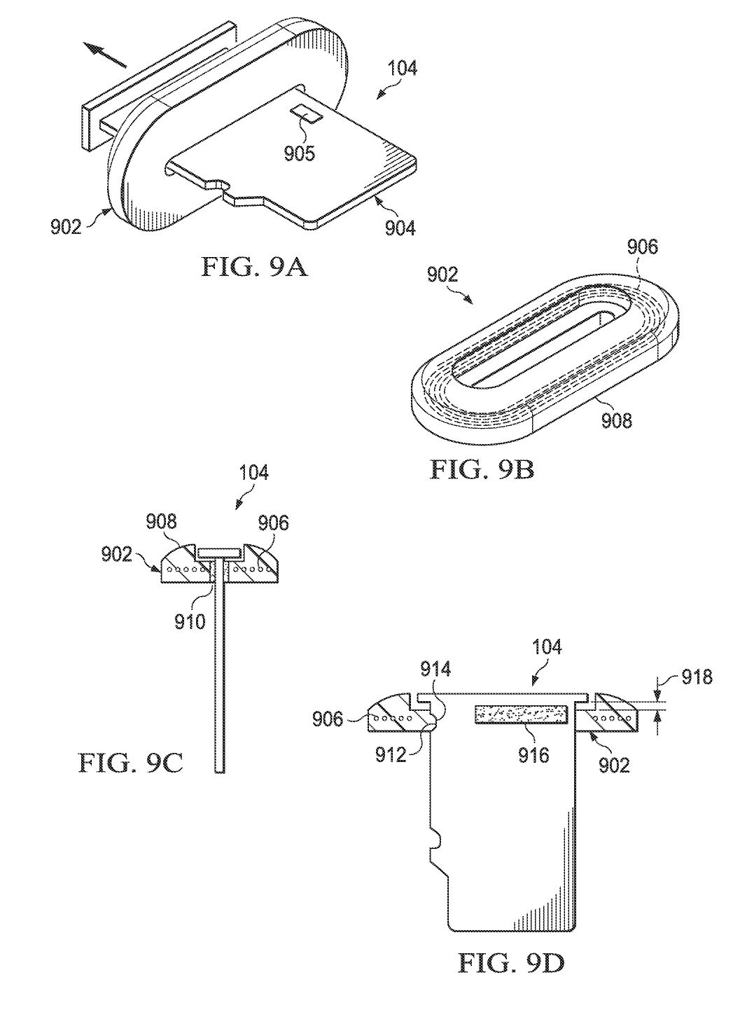

FIGS. 10A and 10B illustrate another implementation of the reader 104. In the illustrated implementation, the reader 104 includes an antenna element 1002 connected to a card element 1004. The card element 1004 may include the same or substantially the same dimensions as a standard MicroSD card such that the card element 1004 may be inserted into an SD slot. The antenna element 1002 may be attached to a surface of, for example, a mobile device 106. In the illustrated element, the antenna element 1002 includes a base 1005 affixed to a surface and configured to receive a pad 107. For example, the base 1005 may be configured to secure the pad 107 adjacent a surface of the mobile device 106 as illustrated in FIG. 10B. In some implementations, the base 1005 may include an adhesive plastic base including a detachable perforation 1006. The pad 1007 may extend around a mobile device and attaches to the base 1005. In some examples, the base 1005 and the pad 1007 may form a thin and flat sticker on the surface of the phone. The pad 1007 may include an antenna 1003, a non-adhesive pad 1008, and/or peripherals elements 1010. The outside portion of the pad 1007 may include a plastic inlay enclosing the antenna 1003 of the reader 104. The antenna 1003 may include copper coils etched on a very thin plastic film forming one of the layers of the inlay. The antenna 1003 may be connected to the reader chip of the card element 1004 using a connector 1012 (e.g., a flexible thin film) that wraps around the edge of the mobile device 106. The connector 1012 may connect the antenna 1003 to the reader using a tuning circuit that tunes the antenna 1003 to one or more frequencies compatible with, for example, the retail terminal 114. For example, the tuning circuit may tune the antenna 1003 to 13.56 MHz for ISO 14443 related transactions. The base 1005 may include a ferrite material that substantially isolates RF analog signals and the magnetic field from the mobile device 106 (e.g., circuits, battery) in which case the connector may include additional connectivity wires than those used for antenna connection only. The pad 1007 may also contain another peripheral 1010 such as a fingerprint scanner connected to a corresponding logical element in the card element 1004 using the same connector 1014.

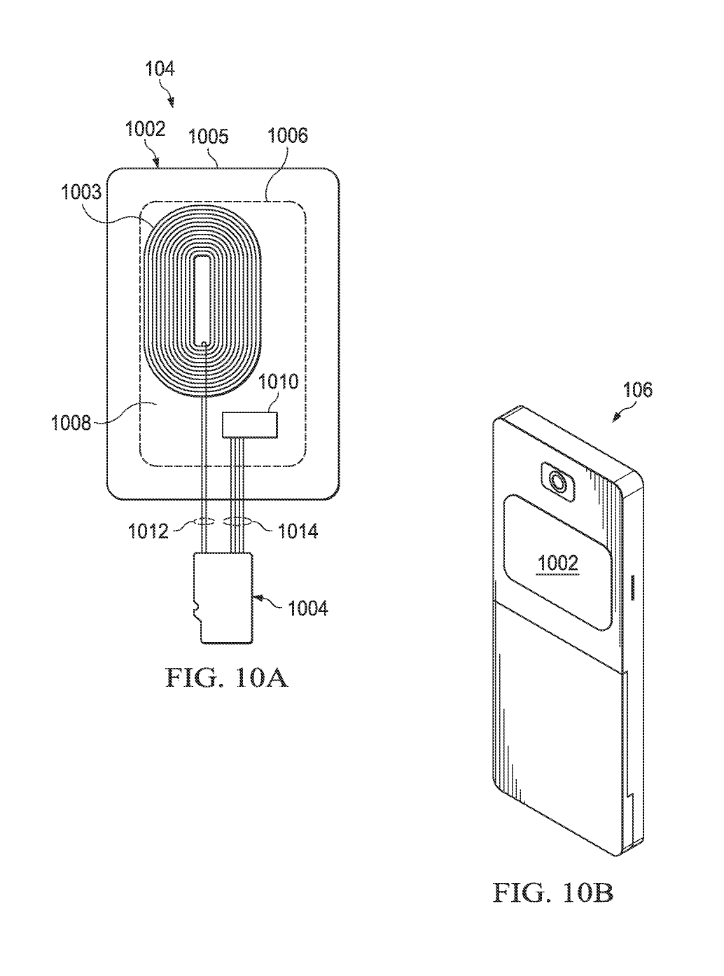

FIGS. 11A and 11B illustrate an example reader 104 including a wireless connection between an antenna element 1102 and a card element 1104. For example, the antenna element 1102 and the card element 1104 may include a wireless connection such as Bluetooth. The card element 1104 may include the same shape and dimensions as a standard MicroSD card such that the card element 1104 is substantially in an SD slot during insertion. The antenna element 1102 may be affixed to a surface of a device housing the card element 1104. In some implementations, the antenna element 1102 can form a thin and flat sticker on the surface of the mobile device 106 as illustrated in FIG. 11B. The antenna element 1102 may include a plastic inlay enclosing at least a portion of the antenna 1104. The antenna 1104 may include a copper coil etched on a very thin plastic film forming one or more layers of the inlay. The antenna 1104 may connect to the card element 1104 (e.g., the reader) using a wireless pairing connection 1113 between a transceiver chip 1114 in the card element 1114 and a corresponding transceiver chip 1108 in the antenna element 1108. In some implementations, the antenna 1104 may be coupled to the card element 1114 through an internal antenna. The wireless connection 1113 may connect the antenna 1104 to the card element 1104 using a tuning circuit that tunes the antenna 1104 to one or more frequencies compatible with, for example, the customer device. The wireless pairing connection used in this case may be in the high frequency spectrum (e.g., 900 Mhz, 2.4 GHz), which are unlicensed and free for use by domestic appliances, for example. For example, the tuning circuit may tune the antenna 1104 to 13.56 MHz for ISO 14443 related transactions. The antenna element 1102 may include a ferrite material that reflects wireless signals to substantially prevent interference with the mobile device 1110. The antenna element 1102 may also contain another peripheral 1110 such as a fingerprint scanner wirelessly connected to a corresponding logical element in the card element using the same wireless connection 1113.

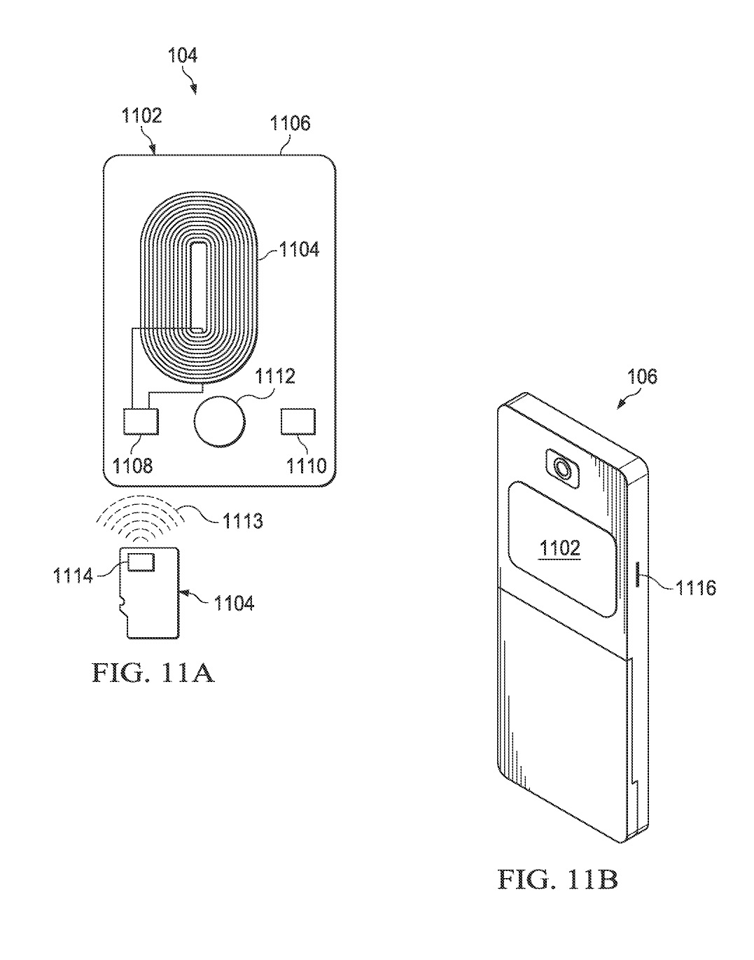

FIGS. 12A and 12B illustrate another implementation of the reader 104. In the illustrated implementation, the reader 104 includes an antenna element 1202 connected to a reader element 1204. The reader element 1204 may include the same or substantially the same dimensions as a standard microSD card such that the reader element 1204 may be inserted into an SD slot. The antenna element 1202 may be attached to a surface of, for example, a mobile device 106. In the illustrated element, the antenna element 1202 includes a base 1005 affixed to a surface and configured to receive a pad 1202. For example, the base 1205 may be configured to secure the pad 1202 adjacent a surface of the mobile device 106 as illustrated in FIG. 12B. In some implementations, the base 1205 may include an adhesive plastic base including a detachable perforation 1206. The pad 1202 may extend around a mobile device and attaches to the base 1205. In some examples, the base 1205 and the pad 1202 may form a thin and flat sticker on the surface of the phone. The pad 1202 may include an antenna 1203, a non-adhesive pad 1208, and/or peripherals elements 1210. The outside portion of the pad 1202 may include a plastic inlay enclosing the antenna 1203 of the reader 104. The antenna 1203 may include copper coils etched on a very thin plastic film forming one of the layers of the inlay. The antenna 1203 may be connected to the reader 104 using a connectors 1212a and 1212b that wraps around the edge of the mobile device 106. The connector 1212 may connect pads 1214a and 1214b to the antenna 1203. The base 1205 may include a ferrite material that substantially isolates RF analog signals and the magnetic field from the mobile device 106 (e.g., circuits, battery) in which case the connector may include additional connectivity wires than those used for antenna connection only. The pad 1202 may also contain another peripheral 1210 such as a fingerprint scanner connected to a corresponding logical element in the reader 104 using the same connector 1214.

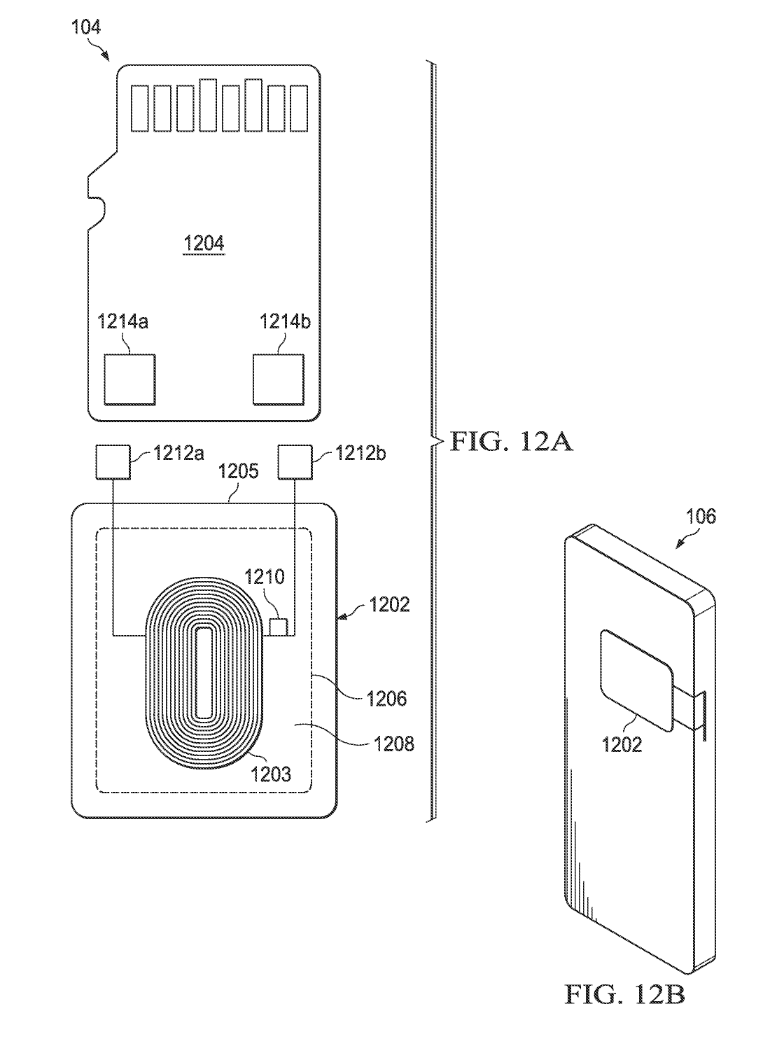

FIGS. 13A and 13B illustrate example mobile devices 106 that include internal antennas 1302. For example, the antenna 1302 may be connected to the reader 104 through, for example, circuits within the device 106. Referring to FIG. 13A, the mobile device 106 includes the antenna 1302 enclosed, encapsulated or other otherwise include in the panel 1304. The panel 1304 may be a back panel to the mobile device 106, a battery cover for the mobile device 106, a display screen of the mobile device 106, and/or other panel. In this implementation, the antenna 1302 may be connected or otherwise coupled to a reader 104 connected to the mobile device 106. Referring to FIG. 13B, the antenna 1302 is included in the mobile device 106. For example, the antenna 1302 may be included on the motherboard of the mobile device 106, affixed to an interior surface of the housing of the mobile device 106, or otherwise included within the housing of the mobile device 106.

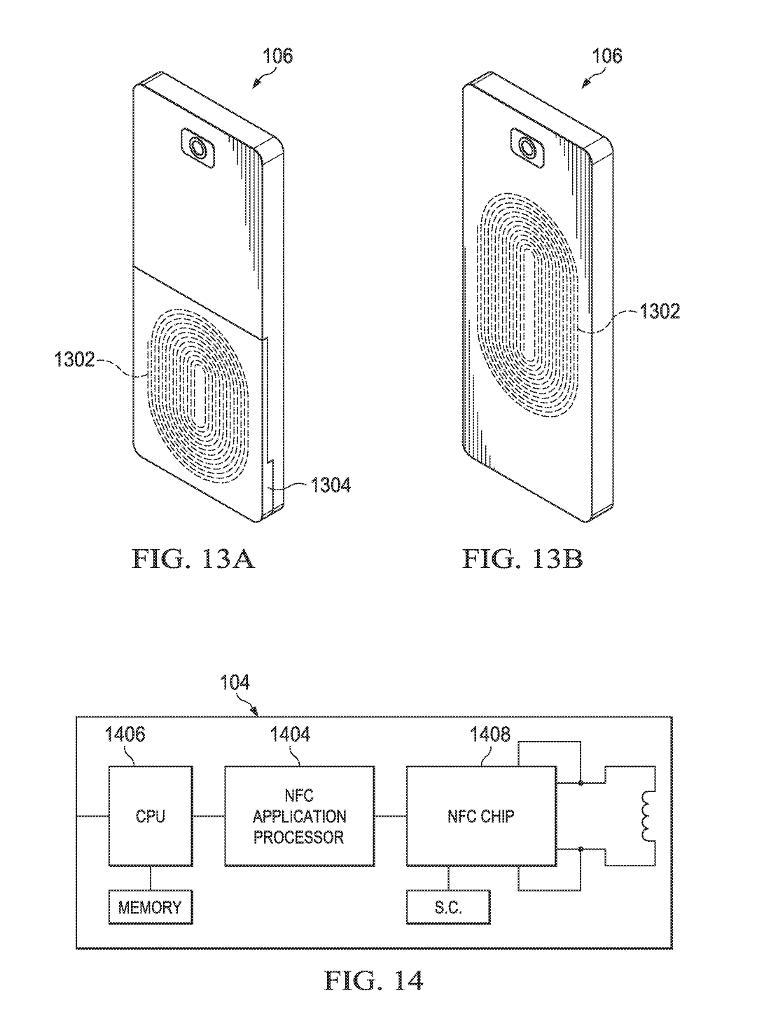

FIG. 14 illustrates yet another example reader 104 that includes an NFC application processor 1404. The application processor 1404 executes the reader functionality independent of the mobile phone processing confidential information. For example, the processor 1404 may process customer credentials, generate an authorization request including encrypted confidential information, and transmit the authorization request to third parties using the mobile phone's wireless connection. In the illustrated implementation, the NFC application processor 1404 can be a chip connected between the CPU 1406 and the reader chip 1408. The NFC application processor 1404 may be configured to implement the NFC stack (3 modes of operation, conformance with multiple card types, generation of events, etc.). The reader 104 may house the processor 1404 in any suitable form such as a microSD card, USB dongle, a circuit package, and other form factors. In some implementations, the processor 1404 may be embedded in attachment to a mobile device such as a cradle, cover, and/or others.

A number of embodiments of the invention have been described. Nevertheless, it will be understood that various modifications may be made without departing from the spirit and scope of the invention.

What is claimed:

1. An attachment for a mobile device, comprising:
an electrical interface configured to connect to a port of mobile devices, the mobile device configured to wireless communicate with a cellular network;
an antenna configured to wirelessly communicate signals with customer devices; and
a reader module connected to the antenna and configured to operate as a wireless reader, using the antenna, to the customer devices and authorize transactions using the mobile device to connect to the cellular network.

2. The attachment of claim 1, wherein the attachment comprises a cover or a cradle for the mobile device.

3. The attachment of claim 1, wherein the antenna and the reader module are integrated into the attachment.

4. The attachment of claim 1, wherein the attachment comprises a card insertable into the mobile device.

5. The attachment of claim 1, wherein the electrical interface comprises at least one of a SecureDigital (SD) interface, a miniSD interface, a microSD interface, a MMC interface, a miniMMC, a microMMC, a firewire or an iDock interface, or a Universal Serial Bus (USB) interface.

6. The attachment of claim 1, wherein the wirelessly communicated signals include at least one of contactless signals, proximity signals, Near Field Communication (NFC) signals, Bluetooth signals, Ultra-wideband (UWB) signals, or Radio Frequency Identifier (RFID) signals.

7. The attachment of claim 1, wherein the wirelessly communicated signals include confidential information, the reader further operable to encrypt the confidential information before using the cellular network to execute the transactions.

8. The attachment of claim 1, wherein the reader module configured to operate as a wireless reader comprises the reader module configured to operate as a wireless Point of Sale (POS) device.

9. The attachment of claim 1, further comprising a plurality of electrical interfaces for a plurality of different peripherals.

10. The attachment of claim 1, wherein the plurality of different peripherals comprises at least one of a document scanner, a biometric scanner, or a printer.

11. The attachment of claim 10, wherein the plurality of different peripherals includes a biometric scanner, and the reader module further configured to verify an identity of an individual based on signals from the biometric scanner.
